(19) United States
(12) Patent Application Publication
(10) Pub. No.: US 2008/0046284 A1
(43) Pub. Date: Feb. 21, 2008

(54) Therapy system and method for treating and reducing risk factors associated with overweight and obesity

(76) Inventors: Maria C. Fisher, Arlington, TX (US); Brian H. Fisher, Arlington, TX (US)

Correspondence Address: LYNN E BARBER, P O BOX 16528, FORT WORTH, TX, 76162, US

(21) Appl. No.: 11/505,024

(22) Filed: Aug. 15, 2006

(51) Int. Cl. G06Q 10/00; G09B 23/28

(52) U.S. Cl. 705/2; 434/262

(57) ABSTRACT

A therapy system and method for treating and reducing risk factors associated with overweight and obesity in patients, especially children in a medical clinic setting having facilities for personal training of patients, and personnel including at least one physician who is also a certified personal trainer.

### BACKGROUND OF THE INVENTION

1. Field of the Invention

This invention relates to risk factors associated with overweight and obesity, particularly in children and adolescents, and in particular relates to a system and method for treating and reducing these risk factors.

2. Description of the Related Art

Childhood obesity is a problem that has been increasing dramatically as the average amount of daily exercise decreases and high-calorie food intake increases. Depending on the state in the U.S., anywhere from 25-40 percent of the population of children is deemed obese. Consequences of this increased childhood obesity are an increased incidence of adult diseases and conditions such as depression, hypertension, osteoporosis, and early CAD (coronary artery disease), in turn leading to a marked decrease in life expectancy.

It is well-known that overweight and obesity, particularly in children, can increase the risk of heart disease, including myocardial infarction, diabetes type II and stroke. Associated with overweight and obesity is a whole metabolic syndrome, including essential hypertension, hyperlipidemia, hypertriglyceridemia, insulin resistance/Type I, and Type II diabetes, hypercholesterolemia, and metabolic syndrome which includes the patient identified with three out of five risk factors. These are triglycerides greater than or equal to 150 mg/dl, insulin resistance or fasting blood sugar greater than 110, waist to hip circumference greater than 0.85 or waist circumference of 35 inches in a female or 40 inches in a male, and high blood pressure (systolic BP greater than or equal to 130 and/or diastolic BP greater than or equal to 85) American Heart Association Spring 2006. Concomitant joint pain or osteoarthritis secondary to obesity is common, resulting in the need to modify exercise treatment so as not to aggravate the pain or cause further medical problems. While these general characteristics are associated with overweight and obesity, individual patients may have unique physiologies (e.g., asthma) causing them to respond differently to different dieting and exercise regimes and to require special evaluation and treatment, as well as having unique home and school environments, and thus the children may require individualized treatment and weight-reduction programs.

This problem of overweight in children is well-recognized, and numerous attempts have been made to address it. Exercise programs at school and elsewhere, removal of fast-foods from the school environment, lectures to parents, diet plans, and the like have been attempted with mixed results. Generally such efforts are focused in a limited area, e.g., caloric intake or exercise with the sole goal being the reduction in weight, without the associated goal of reducing the risk factors associated with the overweight, nor of monitoring such risk factors. Further, such programs often do not address or consider the child's individual physiology, anatomical limitations, attitude and psychosocial and family environment, with the result that the programs may be ineffectual for many of the patients.

Personal fitness trainers teach safe, effective, individualized exercises to clients in a one-on-one type setting, and assist clients in achieving their personal fitness and wellness goals as well as positive lifestyle change. Thus, personal trainers have been employed to help clients lose weight. While the exercises designed by personal fitness trainers may be effective in weight loss, personal fitness trainers legally cannot address medical concerns and problems or often must refer specific questions to other professionals on medical concerns about exercise, calorie expenditure, healthy eating, weight loss, injuries and the like.

Personal fitness training programs are generally designed for adults, and personal trainers generally are not educated or trained in fitness for children, who cannot just be treated like “little adults”. Children's exercises and their use of exercise equipment must be supervised. Even if designed for children, such programs that are not under a doctor's direct supervision usually do not take the child's overall health or medical parameters into account at all, or if an initial medical evaluation is done, do not monitor the children's medical factors in an ongoing manner, nor are they customized for particular children. While parents can seek periodic medical consultation for their children during personal fitness training or other weight loss programs, there is no coordination between the attempts to treat the symptom, i.e., to cause the child to lose weight, and the monitoring of the associated risk factors, and in fact, such risk factors are often ignored.

In addition, in traditional weight loss programs, additional risk factors that may arise from intensive dieting or exercise programs are not monitored, and the child's overall health is not evaluated during the programs to be sure that there are not undesirable side-effects from the programs.

Most weight loss exercise programs are at a facility under the supervision of a teacher or personal trainer, and do not directly involve a physician or pediatrician or the child's parents or guardian.

It is therefore an object of the invention to provide a system and method for treating and reducing risk factors associated with overweight and obesity, particularly in children.

Other objects and advantages will be more fully apparent from the following disclosure and appended claims.

### SUMMARY OF THE INVENTION

The invention herein is a therapy system and method for treating and reducing risk factors associated with overweight and obesity in patients, especially children. In a medical clinic setting having facilities for personal training of patients, personnel including at least one physician who is also a personal trainer and at least one personal fitness trainer, adding personnel of medical or fitness background such that the ratio of staff to children is approximately no greater than 1:4. It is imperative that the physician is also a personal trainer as this knowledge is what allows him or her to appropriately assess the child medically and physically in terms of fitness, with the child's limitations and abilities interconnected by both fields.

Other objects and features of the inventions will be more fully apparent from the following disclosure and appended claims.

### DETAILED DESCRIPTION OF THE INVENTION AND PREFERRED EMBODIMENTS THEREOF

The present invention provides a method and therapy system for patients for treating and reducing risk factors associated with overweight and obesity, targeted particularly to overweight children, ages 5-18. The goal of the invention is to improve more than just the weight of the child, but also the cholesterol, lipids, triglycerides, and blood glucose, and to improve the lifestyle (including that of the child's family). In some cases, the invention also works to improve the child's coordination. Thus, the program does not stress the actual weight of the child, but rather, the physical (size) and physiological characteristics associated with that weight.

While the invention herein is particularly tailored to children and adolescents, it is clear to one of ordinary skill in the art that certain aspects of the invention may be valuable in the treatment and reduction of risk factors associated with overweight and obesity in young and older adults.

The invention herein utilizes the combined strengths, education, and skills of two divergent fields that are tightly linked together in the invention—those of medical therapy, particular pediatric, to reduce risk factors associated with overweight and obesity, and those of personal training to increase fitness. The term “fitness and medical clinic”, (or the term “medical clinic” or “clinic”) are used herein to identify the combined personnel and facilities that carry out the method of the invention, and which utilize the services and expertise of a personal trainer and of medical personnel (physician), most preferably including a pediatrician.

Thus the therapy system for patients for treating and reducing risk factors associated with overweight and obesity of the invention herein includes the following main components:
a) a medical clinic having facilities for personal training of patients;
b) clinic personnel comprising at least one physician and at least one personal fitness trainer; ancillary staff including one medical assistant or licensed vocational nurse or registered nurse as there often are minor medical emergencies which require attention;
c) preliminary determination of a profile for each patient and periodic evaluation of each patient profile by the clinic personnel, including labs, medical status, patient risk factors, physical fitness, and nutritional profile;
d) exercise training tailored to the patient and the patient's profile; and
e) a preliminary patient goal tailored to the patient's profile, and adjusted periodically based on changes in the patient profile.

Children are identified for participation in the method and system of the invention by their doctor, parent or guardian, or teacher. Before further participation the program, the child must have a complete physical examination, including heart, blood pressure, neurological exam, Tanner stage, identification of other health risks, and the appropriate lab work. This examination is preferably done by the child's own doctor who knows the child and the child's medical profile.

The system and method of the invention require that the child be supervised and observed by appropriate personnel at all times while in the clinic. Other special considerations with children, for whom this invention is most useful, include knowledge by the clinic personnel of Tanner Stage with associated changes in body fat, with that of females increasing with increased stage and that of males decreasing with increased stage as muscle mass increases. Personnel also need to be knowledgeable about children's and adolescent's emotional differences from adults. Children's progress should be compared to that child's previous progress and not to that of other children. For some children, often younger children, time spent on each exercise may need to be shortened if the child is becoming bored. Also, to increase interest in exercises such as scooter riding and hop balls used to increase heart rate, the trainers might race the children (and let them win).

A wide variety of exercises and exercise regimens for children have been developed as part of the invention, and as adapted from those known in the art, so that they both challenge and exercise the children, and are interesting rather than boring, and are more like play than exercise. It is important that the clinic have a training area that is large enough to allow every individual to be monitored, yet have adequate room. An outside area to run is helpful, as is access to a track of a measured distance. While a “class” may contain only one patient, it is preferred that the children have others there for company and camaraderie. A preferred class maximum is 6-8 patients, assuming there are two trainers.

During the classes, the children are grouped by the amount of time they have been taking the classes, so that multiple children are simultaneously exercising and the resting. The first name of each child and number of minutes in each exercise are predetermined prior to each class. Heart rates are recorded during the session approximately every one and one-half minutes. Last names are not visible to other patients as this would be a violation of HIPAA guidelines.

Parts of equipment that are touched daily are cleaned after each use daily and/or in between patients with either bleach or chlorahexidine.

Most preferably the clinic is equipped for the children at the minimum with a stop watch for each child, a heart rate monitor for each child, a disposable water bottle with the child's name on it, a clipboard for each child to record the child's name and target heart rate, and the child's exercise activity each day and heart rate during each activity. A portable AED if possible with training it its use, and standard personal trainer measuring equipment including a body-fat measuring device, a yardstick, a tape measure, a metronome, a step for use with the step test, 3-inch foam block for push-ups, exercise mats, VO2 Max assessment tool, and sweat rags.

The clinic in the invention is equipped with standard physician equipment and supplies allowing basic medical evaluation and treatment of the patients before and during exercise. The clinic should also include standard physician equipment/supplies including, but not limited to a scale, blood pressure cuff, thermometer, stethoscope, urine cups and dipsticks for urinalysis, oto-ophthalmoscope, rapid strep tests, ace bandages or similar wraps for sprains or strains of extremities, beta-adrenergic inhalers for undiagnosed or diagnosed children with exercise-induced asthma, portable oxygen, standard pediatric life support equipment, ice-packs and juice or other suitable carbohydrate to treat hypoglycemia (low blood sugar often seen with diabetics).

Exercise equipment may be variable, but at a minimum should include equipment to work large muscle groups to improve aerobic capacity and increase target heart-rate such as a treadmill that is child-powered, and not automatic due to injury risk, stationary bicycle, weights, elliptical (machine that allows circular motion of the legs to increase aerobic capacity with little trauma to weight bearing joints), strider (apparatus similar to elliptical for back and forth motion of the legs), step, glider (seated apparatus which allows trunk, leg and shoulder flexion), exercise balls with and without handles, trampoline with handle, and a music player such as a boom-box. Other equipment that additionally works on balance and coordination includes balance boards, Moon Hoppers, and Carpet Skates. Also, equipment that additionally is considered a reward includes various versions of Dance Dance Revolution. New equipment is used on a child-specific basis, and is progressive in difficulty depending on the ability of the child. Age appropriate differences include the use of hop balls vs. hop horse, specific sizing of equipment, and various free and machine weights.

Fresh fruits and vegetables, protein bars, juice popsicles, cereal, nuts, beef jerky, low-fat cheese, cottage cheese, canned fruits on rare occasion, fat-free Ranch dressing are the primary snacks to be given and their contents and benefits discussed. In addition to discussion, also included are questions and answers about the above foods and other topics including stress and its effects on the body, sleep, water, fast food/eating out, good food choices, caloric content, and how to interpret nutrition information.

In its preferred embodiment, the method and system of the invention for treating and reducing risk factors associated with overweight and obesity comprises a medical clinic having facilities for personal training of patients; and personnel comprising at least one dually qualified physician/personal trainer. The personnel together implement a program comprising preliminary and periodic medical screening, preliminary and periodic physical fitness assessment, preliminary and periodic nutritional assessment, preliminary and periodic goal setting, regular exercise training, including weight training, and regular nutrition training with the entire family included to sample the nutritious snack if desired. Extensive medical explanation of the patient's individual risks of overweight, obesity, and any other pathology if left untreated is discussed at the initial interview and periodically as required to reinforce understanding in an effort to effect change. The patients are monitored during the training, and the various assessments are done at least every four weeks.

The age of the child affects training and results, e.g., the effect of puberty. In addition, younger children and extremely heavy children require different equipment, and therefore, the invention particularly includes tailoring the particular treatment to the particular child.

Prior to beginning the therapy system for a particular child for treating and reducing risk factors associated with overweight and obesity, a number of types of background paperwork is done to allow the medical personnel of the fitness and medical clinic to evaluate the child to be sure that the medical therapy of the invention is appropriate. Specific labs including a lipid profile, insulin levels, thyroid levels, comprehensive metabolic panel, complete blood count with differential are obtained prior to attendance at sessions to ensure that the child's overweight/obesity is not due to a dangerous organic illness and/or the illness is well-controlled. Preferably this background paperwork includes obtaining informed consent is obtained from the parent or guardian, specifying the detailed procedures and risks, and that the parent or guardian is responsible for monitoring the child's individual performance during any activity. Parents are not required to attend sessions, but are encouraged to stay for nutrition teaching to increase patient and family compliance. Parents are required to be present during the one-mile walk test. Parents are given instructions on their role, and the family is told that the equipment is for the supervised use of the patient only. Information is also obtained from the parent or guardian for insurance purposes for treating the patient child. Parents may request personal training for themselves done on a scheduled basis, but are not billed through insurance.

A standard PAR-Q (Physical Activity Readiness Questionnaire originally developed by the Canadian Society for Exercise Physiology, Inc.) is filled out for each child addressing the issues of whether the child has ever had a heart condition or felt chest pain when exercising or otherwise, has had dizziness or loss of consciousness, has bone or joint problems that could be worsened by physical activity, is on drugs for blood pressure or heart condition, or has other reason not to do physical activity.

A health history is also obtained for each child prior to enrollment in the clinic. In addition to asking for information on standard diseases and conditions, and for family history of heart, lung and other problems, the form asks for whether the child's physician has made any recommendations regarding exercise for the child, what the child's current level of physical activity is with respect to aerobic exercise, weight training and stretching exercises, and whether the child (or adolescent) smokes or is taking any prescribed medication. There is also preferably a place on this form or elsewhere for the physician/personal trainer at the clinic to assess risk based on personal training standards (American College of Sports Medicine).

It is very important in the system and method of the invention that the child participate regularly, both for efficacy of the program as well as to reduce problems that might be due to an irregular exercise schedule, and therefore, it is preferred to have the parent or guardian sign a No Show without Prior Notification form. In this form they indicate their understanding that if their child does not show for two classes without notifying the clinic, the child will be discontinued from the program.

Because of the success of the system and method of the invention, which has been found to be newsworthy, it is optionally desirable to require the parent or guardian to sign an information release authorization for release of pictures and quotes to the news media.

A Contingency Management Contract is a motivational device for the child such that he/she is required to exercise for at least five hours per week with rewards or consequences to be received after each month depending on compliance.

A Nutrition Assessment Form is filled out by the child initially and after completion of each month to record the foods and beverages consumed at meals and at snacks in the child's typical day. For mixed dishes, ingredients are recorded separately. The number of servings of starches, vegetables, protein source, dairy products, and fats and sweets are recorded. This allows the clinic personnel to do a rough calorie count for the child's typical day and to determine what the percentages of protein, carbohydrates and fat are in the child's diet, and to make recommendations for dietary change. Comparing the child's average caloric intake with the number of calories calculated to be needed by each child using the Harris-Benedict Equation as known in the art for the male or female sex allows the doctor/trainer to determine caloric needs and to explain to the child and the child's parents/guardian how many pounds the child could lose if the caloric intake was scaled back appropriately. Using 3500 calories as equal to one pound (an industry standard), this is extrapolated by estimating the patient's excess caloric intake for 28 days and then dividing this number by 3500 to result in the number of pounds potentially gained without dietary counseling.

In the method and system of the invention, a PFS Fitness Assessment Sheet as is known in the art based on tests administered to the child is filled out for each child before beginning the program, and at periodic intervals during program. Preferably these intervals are no more than one month. This is a modified version of a customary sheet used to log a client's results for assessment of their physical fitness. Leg press, BMI, two types of sit and reach, height, weight, body fat by Jackson and Pollack and/or using triceps and calf (use of either or both) based on Tanner stage of the child are added to the customary sheet). Included in the assessment and physical exam by the doctor/trainer and Tanner stage to determine how to interpret the data and which measurements are required are standard parameters including level 1 screening for body composition (estimate of percent body fat based on pinch tests at standard body sites); level 2 screening using the 3-minute step test followed by pulse check for one minute) with the height of the step being reduced for patients under 4′ 10″; level 3 assessment using a one-minute sit up count to measure dynamic strength); level 3 assessment to measure upper body dynamic strength by counting push-ups in one minute; level 3 assessment of upper body absolute strength with a one repetition bench press (the most the patient can lift one time, but it may take up to 5 to 6 trials to find the child's submaximal level of weight that they can lift), using Universal DVR (dynamic variable resistance—a type of weight resistance machine) or free weights to determine maximum weight lifted; level 3 assessment with a sit and reach test; level 3 assessment in a one mile walk test (proper warm-up, cardiorespiratory fitness, including heart rate monitoring); and level 3 assessment in a one mile run (proper warm-up, emergency procedures in place, visual observation, and proper cool-down). Additional cardiorespiratory tests, such as bike, treadmill, 1.5 mile or 12 minute run may be added to increase the scope of the assessment. In addition, the patient's height and weight are taken and compared to norms, the girth (circumference) of the waist, abdomen, and hips determined, and a Diagnosis of Metabolic Syndrome is done.

During and following the administration of the above tests, the child is visually monitored, and the test stopped if there are any medical concerns. For example, the personnel need to be very aware of hypoglycemia in diabetes patients under treatment. Also, questions are asked about injuries or medical concerns before each exercise set and medical concerns are discussed with the child and parent, with the parent present at all times. For smaller children, the exercise equipment used in the preliminary tests and later is modified as appropriate for their size so that the equipment can be used by them.

A goal setting and assessment plan is set up for each child after obtaining the child's initial data, which plan is revised monthly allowing for patient illness/vacation, etc. After the doctor lists the assessment/plan for the child, the child's fitness is recorded, including current raw scores, current fitness category, goal raw score and goal category for cardiorespiratory endurance (one mile walk), absolute strength (bench press), dynamic strength (sit ups/curl ups, push ups), flexibility (sit and reach), comparing the results to personal trainer standards depending on the Tanner stage of the child and/or the Fitnessgram, body composition (skin fold and other parameters such as waist, abdomen and hip circumferences, and BMI, which is plotted on a graph provided by the CDC).

The information on the child's raw scores and current fitness category for various fitness components, including cardiorespiratory, absolute strength, dynamic strength, flexibility, body composition and anaerobic power (vertical jump and 300 meter run) is also used to determine the child's fitness profile using standard methods. This allows the various aspects of the child's fitness to be identified as to whether they are superior, excellent, good, fair, poor or very poor.

The child's body mass index (BMI) is determined using standard charts, allowing comparison to norms of 10^{th} to 85^{th} percentile and month to month progress. Similarly, overall performance in the various types of exercise and the child's performance in particular exercises is evaluated using standard Fitnessgrame® (Cooper Institute, Dallas, Tex.) which the physician can use to tailor the goal setting for the patient, e.g., Jackson and Pollack, “Practical Assessment of Body Composition”, Phys. Sports Med. 1985, 13(5): 76-90.

Exercise training classes are typically structured as follows; however, it is well within the scope of the invention herein to make variations in times, sequences and the like, so long as the variations are based on sound medical evaluation and implementation. Patients are expected to come to class two or three times per week for two to three months.

During the preferred first month, the class begins with a 10-minute warm-up, which during the first week begins with a standard warm-up routine of chest pulls, side bends, thigh stretch, alternate thigh stretch, seated hamstring stretch, inner thigh stretch, calf stretch, lower back stretch, and other as designated by the personal trainer and/or doctor. This is followed by running one lap (e.g., a 100-yard loop) and walking one lap (or encouragement to do as much of that as they can), and during the second week includes a warm-up followed by running two laps and walking one lap, repeated during the third and fourth weeks. After this warm-up, the patient exercises for 30-45 minutes in circuits (i.e., changing machines and/or equipment): 50% HR max using the Karvonen Equation (Karvonen M, Kentala K, Mustala O. The effects of training on heart rate: a longitudinal study. Ann Med Exp Biol Fenn 1957; 35:307-315). All children wear heart rate monitors while exercising and during the one-mile walk. During the first week the circuits are five minutes with one minute rest, during the second week five minutes without rest, during the third week six minutes without rest, and during the fourth week, seven minutes without rest. After the exercises in the first month, the patient does twelve repetitions of one set of six exercises two days per week including leg press, hamstring curls, bench press, lateral pull-downs, arm curls, and knee extensions. Calf raises are done holding an 8-12 pound weight on the child's shoulders if he/she is too small or too weak to use hamstring curls. Finally, there is a five-minute cool down followed by nutrition training (see below).

During the second month of classes, there is a ten-minute warm-up of running two laps, criss-cross feet drill (as often used by football players, dancers and other athletes) for 100 feet alternating directions left to right and right to left. After warm-up, there are 7-8 minute circuit exercises with 60% HR max., 2-3 minutes Medicine Ball, a standard device used for varying weights, with the ball side to side, overhead, between legs, and side down, side up, and jumping rope 2-3 minutes. There are then fifteen repetitions of one set of six weight training exercises two days per week, followed by changing bench press and leg press weight if the patient is able as evidenced from their reassessment after each month of training, in which case if the bench press and leg press weights increased, this will remain at twelve repetitions per set. Also other weight repetitions are increased from twelve to fifteen or the actual weight is increased in 10-20 pound increments if the child states that the weight is too easy. Finally, there is a five-minute cool down as during the first month.

During the first month, the patient does 90 “crunches” to music one day during the first week, 120 one day during the second week, and 150 one day during the third week to be continued each week thereafter. Crunches are when a special song is played and the children do side sit-ups or trunk lateral flexion, generally in increments of ten, followed by a rest, for 50 side sit-ups on one side, and then repeat for the other side, and then 50 crunches (trunk flexion).

Following the second month, the child may enroll in a third month, but may at that time taper to 1-2 sessions per week, rather than the preferred three for earlier months. By the time the class sessions terminate for a particular child, the child should have a sport to participate in to continue exercising on his or her own.

If the patient requires further treatment after three months and their laboratory results remain abnormal, they may continue if their insurance plan allows or if they are otherwise able to afford treatment. Follow-up evaluations are desired at three and six month intervals after the child is discharged from therapy.

Weight training is structured analogously to weight training for adults in standard personal training except a submaximum weight for each exercise is determined and then the amount of weight lifted is twelve times one-half of the submaximum. Thus, exercises are selected to target large muscle groups to increase muscle tone and metabolism with the goal of a reduction in body fat from the following: leg press, leg extension, leg curl, lat pull, high row, bench press, shoulder press, triceps press, arm curls, calf raises, abdominal, and back extension. Submaximum is used to decrease the risk of crush injury to growth plates in the bones of the growing children.

Nutrition training is offered at the end of each class, including a health snack with explanation of the contents of the snack and a discussion of encouraging healthy choices. The snack, for example, might be fruit cut into bite-size pieces and distributed in individual servings, and include a discussion of complex versus simple carbohydrates, protein going into muscle growth, and fats in moderation being acceptable for particular body needs. The discussion of healthy choices may also include explanation that small amounts of non-nutritional snacks are okay but the patient needs to plan ahead or exercise more. The importance of portion sizes is also discussed.

At the end of each four week period, award certificates are given to the patients. The certificates may be decorated or color-coded to show progress of the patient.

A training log modified for use in the invention herein, listing standard personal fitness training categories (e.g., run/walk, bike, elliptical, stepper) as well as activities developed specifically for children (e.g., hopballs, carpet skates, flying turtles), and time spent on each activity is kept for each child.

During exercises performed by children, the time spent in various exercises and the heart rate of each child is monitored and recorded, and compared to the target heart rate as calculated using the Karvonen equation. The form for recording this information encourages comments by the instructor or observer.

A number of other calculations as known in the art allow the trainer or doctor or both to better assess the child's progress. These include standard calculation of VO₂ (see Kline et al., Estimation of VO2 Max from a one mile track. Medicine and Science in Sports and Exercise 19(3):253-259, 1987) which indicates the child's cardiovascular fitness, the Harris-Benedict Equation allowing the number of calories that the particular child requires each day to be calculated based on the child's sex, weight, height and activity level, and the number of calories that the child's diet must be reduced to result in weight loss.

The system and method of the invention are sufficiently flexible to allow the clinic medical and training personnel to work together. Thus, the doctors may use the measures of cardiovascular and other types of fitness as deemed most appropriate in their best medical judgment to determine how the training received by each child is affecting the child's medical profile, and to allow the personal training personnel to take the medical data obtained on each child and utilize it to determine the types of training most appropriate for the child's medical goals.

In addition to the above medical and exercise components, the children taking classes provided as part of the method and system of the invention are given basic nutritional information to assist them and their parents in the child's nutritional intake. Typically, at the end of each class, after the children have cooled down, the children are given a healthy snack along with an explanation of the value of the snack components. Labeled (with child's name) bottled water is given and available before class and throughout. In addition, handouts are provided explaining the basic food groups and providing information on what and how much of each group the child should be eating each day. Follow-up with newsletters having articles featuring healthy snacks, recipes, and dietary tips augments the in-class regimen.

Parents are allowed to watch the entire class, but are only allowed to warm-up and/or do crunches if space is available due to health-related liability risks for the exercising adult. A waiver may be issued.

The method and system of the invention require the child to warm-up before exercising, and therefore children are required to be on time for the exercise classes. If, however, a class is underway and has already warmed up when the parent brings the child, it is possible to allow the child to participate, so long as the parent or guardian is advised of the potential risks and signs a form allowing exercise without warm-up, and assuming responsibility for medical care that may be required for this.

Examples of results obtained in applicant's clinic using the method and system of the invention are as follows:

An 8 year old female with 33.7% body fat lost 6 pounds and decreased her body fat to 26.4%. Her total cholesterol decreased from 182 to 169, triglycerides from 129 to 127, and LDL cholesterol from 127 to 117 in approximately eight weeks. A 13 year old female with a 27.5% body fat lost one pound and 2% body fat, but her triglycerides decreased from 187 to 143, her LDL cholesterol went from 100 to 112, but her insulin level went from 25 to 9.3 after approximately 4 weeks in the program. A 7 year old boy with a 31.8% body fat decreased to 18.6% (now normal). His total cholesterol went from 231 to 163, his insulin decreased from 5 to 3.5, triglycerides from 106 to 61, LDL cholesterol from 163 to 122 and HDL cholesterol from 47 to 51 after approximately twelve weeks in the program. A 12 year old male with a body aft of 40.0% decreased to 27.5%, triglycerides decreased from 150 to 102, total cholesterol decreased from 202 to 184, LDL cholesterol from 133 to 126, and insulin level from 27 to 9 in approximately twelve weeks.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A therapy system for patients for treating and reducing risk factors associated with overweight and obesity, comprising:
a) a medical clinic having facilities for personal training of patients;
b) clinic personnel comprising at least one physician and at least one personal fitness trainer;
c) preliminary determination of a profile for each patient and periodic evaluation of each patient profile by the clinic personnel, including medical status, patient risk factors, physical fitness, and nutritional profile;
d) exercise and nutrition training tailored to the patient and the patient's profile; and
e) a preliminary patient goal tailored to the patient's profile, and adjusted periodically based on changes in the patient profile.

2. The therapy system of claim 1, wherein the patients are selected from the group consisting of children and adolescents, and the physician is a pediatrician.

3. The therapy system of claim 1, wherein the exercise training utilizes equipment selected from the group consisting of treadmills, stationary bicycles, weights, ellipticals, striders, steps, gliders, exercise balls, and trampolines.

4. The therapy system of claim 1, wherein the medical clinic is equipped with a stop watch for each patient, a heart rate monitor for each patient, a labeled disposable water bottle for each patient, and a clipboard to record each patient's exercise information.

5. The therapy system of claim 1, wherein the medical clinic is equipped with standard physician equipment and supplies allowing basic medical evaluation and treatment of the patients before and during exercise.

6. A method for treating and reducing patient risk factors associated with overweight and obesity, comprising the steps of:
a) providing a medical clinic having facilities for personal training of patients;
b) providing personnel comprising at least one physician and at least one personal fitness trainer;
c) making a preliminary determination of a profile for each patient and periodic evaluation of each patient profile by the clinic personnel, including medical status, patient risk factors, physical fitness, and nutritional profile;
d) providing exercise and nutrition training tailored to the patient and the patient's profile; and
e) determining a preliminary patient goal tailored to the patient's profile, and adjusted periodically based on changes in the patient profile.

7. The method of claim 6, wherein the patients are children and the physician is a pediatrician.

8. The method of claim 6 wherein the exercise training utilizes equipment selected from the group consisting of treadmills, stationary bicycles, weights, ellipticals, striders, steps, gliders, exercise balls, and trampolines.

9. The method of claim 6, further comprising calculating each patient's cardiovascular fitness and calculating the number of calories that each patient requires each day.

10. The method of claim 6, wherein the medical clinic is equipped with a stop watch for each patient, a heart rate monitor for each patient, a labeled disposable water bottle for each patient, and a clipboard to record each patient's exercise information.

11. The method of claim 6, wherein the medical clinic is equipped with standard physician equipment and supplies allowing basic medical evaluation and treatment of the patients before and during exercise.

12. The method of claim 6, further comprising providing a contingency management contract to motivate the patient to exercise.
